(19) United States
(12) Patent Application Publication
(10) Pub. No.: US 2017/0247581 A1
(43) Pub. Date: Aug. 31, 2017

(54) PROTECTION OF NEW ELECTRO-CONDUCTORS BASED ON NANO-SIZED METALS USING DIRECT BONDING WITH OPTICALLY CLEAR ADHESIVES

(71) Applicant: 3M INNOVATIVE PROPERTIES COMPANY, St. Paul, MN (US)

(72) Inventors: Ying Zhang, Woodbury, MN (US); Albert I. Everaerts, St. Paul, MN (US); Dong-Wei Zhu, North Oaks, MN (US); Ross E. Behling, Woodbury, MN (US); Gregg A. Caldwell, Cottage Grove, MN (US)

(21) Appl. No.: 15/507,354

(22) PCT Filed: Sep. 1, 2015
(86) PCT No.: PCT/US2015/047847

§ 371 Date: Feb. 28, 2017

Related U.S. Application Data
(60) Provisional application No. 62/044,689, filed on Sep. 2, 2014.

(51) Int. Cl. C09J 11/06; C09J 5/00; H01B 1/02; C09D 133/08

(52) U.S. Cl. CPC C09J 11/06; C09D 133/08; C09J 5/00; H01B 1/02; H01B 1/026; C08K 5/3475

(57) ABSTRACT

The present invention is an adhesive composition for stabilizing an electrical conductor. The adhesive composition includes a base polymer and an additive for absorbing UV light, such as a benzotriazole or a benzophenone. When the adhesive composition is in contact with the electrical conductor, the electrical conductor has less than about a 20% change in electrical resistance over a period of about 500 hours.

### FIELD OF THE INVENTION

The present invention is related to optically clear adhesive compositions. In particular, the present invention is related to optically clear adhesive compositions that can stabilize electrical conductors.

### BACKGROUND

Over the past few decades, transparent, electro-conductive films have been used extensively in applications such as touch panel displays, liquid crystal displays, electroluminescent lighting, organic light-emitting diode devices, and photovoltaic solar cells. Indium tin oxide (ITO) based transparent conductive films have been the choice for most applications. However, ITO based transparent conductive films have limitations due to the need for complicated and expensive equipment and processes, relatively (vs. pure metal) high resistance, and inherent brittleness and tendency to crack; especially when deposited on flexible substrates. New conductors based on metallic nanoparticles, nanorods, and nanowires have seen significant technical advances in recent years and printed patterns, randomized patterns (to minimize visibility and Moire), and metal meshes (derived from nano-sized metallic material) have become much more attractive to the electronics industry. Metallic conductors based on silver and copper are perhaps the most common. Particular examples are silver nanowires (SNWs). SNW-based films impart high conductivity, high optical transmission, superior flexibility and ductility at a moderate cost, which make them a desirable alternative for ITO in many applications; especially for thinner and more flexible devices.

However, it is very challenging to keep SNWs stable for long periods of time because they can be sensitive to light and environmental exposure. One such example is the UV induced degradation of the conductive traces of a SNW-based touch panel in the viewing area of a display and/or near the ink edge (the black or white ink border around the display). This degradation can result in a sudden loss of conductivity and thus also a loss of touch panel function, possibly due to photo-oxidation of the SNW. Some of the literature suggests that the so-called plasmon resonance of silver can facilitate the silver oxidation to silver oxide.

### SUMMARY

In one embodiment, the present invention is an adhesive composition for stabilizing an electrical conductor. The adhesive composition includes a base polymer and a UV absorber, such as a benzotriazole or a benzophenone. When the adhesive composition is coated on the electrical conductor, the electrical conductor has less than about a 20% change in electrical resistance over a period of about 500 hours of light exposure.

In another embodiment, the present invention is a method of stabilizing an electrical conductor. The method includes providing an adhesive composition and coating or laminating the adhesive composition on the electrical conductor. The adhesive composition includes a base polymer and an additive for absorbing UV light. When the adhesive composition is coated on the electrical conductor, the electrical conductor has less than about a 20% change in electrical resistance over a period of about 500 hours of light exposure.

### BRIEF DESCRIPTION OF THE DRAWINGS

FIG. 1A is a top view of a sample construction for measuring the change in electrical resistance of a silver nanowire film.

FIG. 1B is a side view of the sample construction shown in FIG. 1A for measuring the change in electrical resistance of a silver nanowire film.

These figures are not drawn to scale and are intended merely for illustrative purposes.

### DETAILED DESCRIPTION

The present invention is an optically clear adhesive (OCA) composition that provides stability to nanowire sensors under various light exposure conditions. The optically clear adhesive composition includes a base polymer and an additive for absorbing UV light. The base polymer can be selected from any optically clear adhesive polymer. The additive includes an ultraviolet (UV) light absorber. In some embodiments, the adhesive composition may also include one of a hindered amine light stabilizer (HALS) and an anti-oxidant. The OCAs of the present invention can stabilize electrical conductors based on metallic nanoparticles, nanorods, and nanowires used, for example, in touch screens, electromagnetic shielding, photovoltaic panels, metal meshes, transparent heating wire patterns for windows, etc. When exposed to UV and visible light, these metallic conductors may be susceptible to degradation, causing a loss in conductivity. By applying the OCAs of the present invention directly on the conductor, costly protective coatings (i.e., barriers) can be avoided and the assembly process of the articles can be simplified. The present invention also covers methods of use and articles containing such OCAs in contact with the metallic conductors.

The optically clear adhesive compositions of the present invention may be pressure-sensitive or heat-activatable in nature. Likewise, they can be applied as a film adhesive, directly dispensed as a hot melt, or applied as a liquid OCA and cured in the final assembly.

The adhesive composition of the present invention includes a base polymer. While adhesive compositions derived from an acrylic base polymer, and in particular, a random (meth)acrylic copolymer, are preferred because of their moderate cost and wide availability, other polymers can also be used as the matrix for the adhesive composition without departing from the intended scope of the present invention. Examples of other polymers include, but are not limited to: polyesters, polyurethanes, polyureas, polyamides, silicones, polyolefins, acrylic block copolymers, rubber block copolymers (i.e., polystyrene-polyisoprene-polystyrene (SIS), polystyrene-poly(ethylenebutylene)-polystyrene (SEBS), polystyrene-poly(ethylenepropylene)-polystyrene (SEPS), etc.), and combinations thereof. Where optically clear blends are obtained, mixtures of these polymers (including the (meth)acrylates) can also be used.

The polymers may be commercially available or they can be polymerized by conventional means, including solution polymerization, thermal bulk polymerization, addition polymerization, ring-opening polymerization, emulsion polymerization, UV or visible light triggered bulk polymerization, and condensation polymerization.

The adhesive composition of the present invention also includes at least one additive that is capable of interfering or preventing photo-oxidation of the metallic conductor, for example, by absorbing UV light. The additive functions to either interfere or prevent oxidation of the metallic conductors when exposed to UV light, such as when the adhesive composition is cured. The adhesive composition of the present invention thus includes a UV absorber.

UV absorbers function to absorb UV light in the range of about 295 and about 400 nm and dissipate it as thermal energy in order to reduce UV degradation or photo-oxidation of the electrical conductor. The amount of UV absorber present in the adhesive composition will depend on the thickness of the adhesive composition, the extinction coefficient of the UV absorber and the amount of UV light to be blocked. Thus, for a given extinction coefficient, the thinner the adhesive layer, the higher the additive concentration must be to maintain a particular absorbance. Examples of suitable UV absorbers include, but are not limited to, benzophenone and benzotriazole. An example of a particularly suitable benzotriazole UV absorber includes, but is not limited to, 2-(2-hydroxyphenyl)-benzotriazoles. An example of a suitable benzophenone UV absorber includes, but is not limited to, 2,2′-dihydroxybenzophenone. Examples of suitable commercially available UV absorbers include, but are not limited to: CYASORB UV-5411, available from CYTEC located in Woodland Park, N.J.; TINUVIN 328, available from BASF located in Florham Park, N.J.

In some embodiments, to further increase the stability of the metallic conductors in contact with the adhesive composition, the adhesive composition further includes at least one of a hindered amine light stabilizer (HALS) and an anti-oxidant. Hindered amine light stabilizers (HALS) function as a stabilizer against degradation caused by light. HALS differ from UV absorbers in that they do not absorb longer wavelength (i.e. UVB and UVA) UV light, rather, HALS acts as a synergist to prevent the degradation of the electrical conductor. HALS are derivatives of 2,2,6,6-tetramethyl piperidine. An example of a suitable commercially available HALS includes, but is not limited to, TINUVIN 123 available from BASF located in Florham Park, N.J.

Anti-oxidants function to interfere with photochemically initiated degradation reactions and thus inhibit the oxidation of the electrical conductors. While anti-oxidants are known to interfere with the oxidation process, they have not previously been known in the art to be used in combination with readily oxidizable metallic conductors, such as nanoparticles, nanorods or nanowires. Examples of suitable anti-oxidants are those sold under the tradename IRGANOX (i.e., IRGANOX 1010, IRGANOX 1024 and IRGANOX 1076) from BASF located in Florham Park, N.J. or CYANOX from CYTEC located in Woodland Park, N.J. Natural anti-oxidants such as ascorbic acid may also be used, provided that it is soluble in the adhesive matrix.

The minimal amount of additive required in the adhesive composition depends on the environmental exposure conditions and the amount of change in electrical resistance that will be tolerated. In one embodiment, the additives are present in the adhesive composition at about 5% by weight or less of the dry adhesive coating. In one embodiment, the additives are present in the adhesive composition at least at about 0.1% by weight. In one embodiment, the additives are present in the adhesive composition at between about 0.5 and about 3% by weight.

The additive significantly improves the stability of the conductors when in contact with the optically clear adhesive, even under quite harsh light exposure. Stability is measured by change in electrical resistance over a given period of time. Without being bound by theory, it is believed that stabilization interferes with the photo-oxidation process. In one embodiment, the resistance of the electrical conductor coated with the adhesive composition of the present invention will have a change in resistance of less than about 20%, particularly less than about 10% and more particularly less than about 5% over a period of about 3 weeks (about 500 hours) of light exposure.

When the adhesive composition must be optically clear, the additives should be miscible in the adhesive matrix so as to result in minimal to no impact on the optical properties of the adhesive composition so that the final formulation retains its optical clear property. “Optically clear” means having a high visible light transmission of at least about 90%, a low haze of no more than about 2% while also being color neutral and non-whitening. However, in some cases, such as with diffuse adhesives, the optical requirements may not be as stringent. While the adhesive composition has been described primarily as an optically clear adhesive throughout this specification, the same additives may also be used in photo-resists that directly contact with the metallic conductor for example, or as part of the nano-sized metal particle dispersion itself, such as a silver nanowire ink.

The additives must also have no effect on the mechanical durability of the display assembly using the adhesive composition. In one embodiment, the adhesive composition has a 180 degree peel force of over at least about 30 oz/inch (˜33 N/dm), particularly over at least about 40 oz/inch (˜44 N/dm) and more particularly over at least about 50 oz/inch (˜55 N/dm) after a 20 minute or a 72 hour dwell time. The additives should also be soluble in the adhesive matrix.

Depending on the manufacturing process used to make the adhesive composition, the additives may also be required to be compatible with the polymerization, coating, and curing processes used to produce the adhesive composition. For example, there must not be significant retardation or interference with the UV polymerization or curing process. In some embodiments, the additives must also be non-volatile in a solvent or hot melt coating process.

In one embodiment, in order to improve environmental durability, the adhesive composition may include a crosslinker. The polymers of the adhesive composition may be crosslinked using methods well-known in the art, including, for example, physical crosslinking (like high Tg grafts or blocks, hard segments, small crystallites, etc.), ionic crosslinking (such as carboxylic acid with a metal ion or acid/base type crosslinking), and covalent crosslinking (such as multifunctional aziridine with carboxylic acids, melamine with carboxylic acid, copolymerization of multifunctional (meth) acrylates, and hydrogen abstraction mechanism, such as with benzophenone or anthraquinone compounds).

The present invention addresses a rapidly emerging need for protecting new electro-conductors derived from nano-sized metals, such as silver and copper. The combination of the base polymer with the additives not only provide environmental protection to these conductors, but most of them are also compatible with UV curing processes, including those used for liquid OCAs, some photoresists that may be used in patterning of the conductors, and the one-web polymerization process used in production of OCAs.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Preparation of Test Coupons

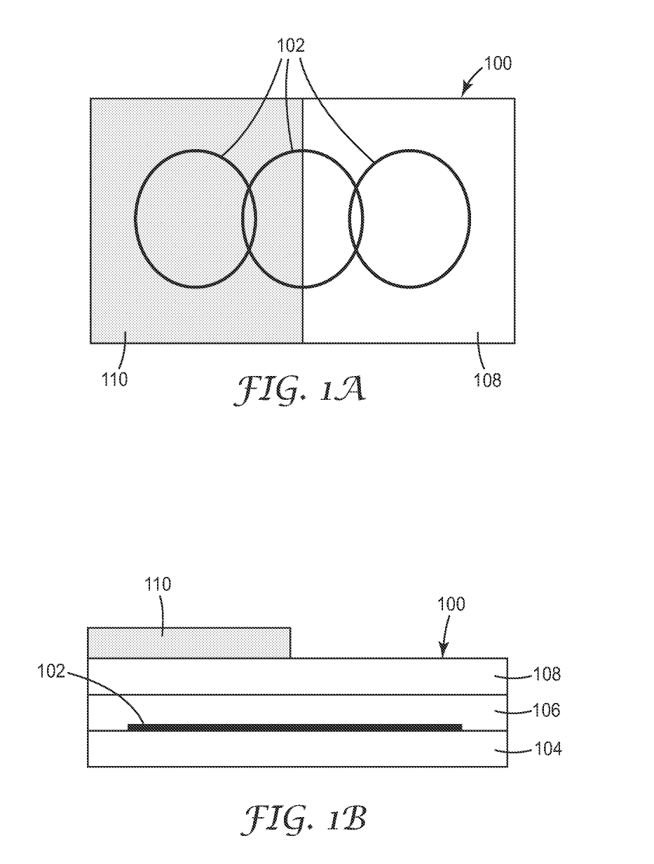

FIGS. 1A and 1B show top and side views, respectively, of test coupons 100 which represent a sample construction for measuring the change in electrical resistance of a silver nanowire film. Silver nanowires 102 (SNW) were created by coating silver ink (Cambrios Technologies Corporation, Sunnyvale, Calif.) on polyester (PET) film 104. The coating resistance was typically about 50 Ohm/sq. The release liner was removed from one side of a 2 inch by 3 inch piece of optically clear adhesive (OCA) strip 106 and the OCA strip was placed in direct contact with the side of the PET film 104 coated with silver nanowires 102. The OCA strip 106 was secured with four passes of a small rubber hand roller, making sure no air bubbles were entrapped between OCA 106 and SNW coating 102. The second liner was removed from the OCA and the OCA/silver nanowire film assembly was laminated onto a 2 inch by 3 inch glass microscope slide 108. As shown in FIGS. 1A and 1B, half of the glass slide 108 opposite the OCA/silver nanowire film assembly was covered with black electrical tape 110 and the other half was left open. The test coupon 100 was irradiated by a xenon arc lamp from the side covered with the tape, so light either passed through the glass or was blocked by the black tape 110.

### Method for Measuring Silver Nanowire Film Resistance Change

The resistance change was measured in each of the three different circled areas of the test coupon using a DELCOM 707 CONDUCTANCE MONITOR (Delcom Instruments, Inc., Minneapolis, Minn.) and testing results are summarized in Table 1, Table 2, and Table 3. The measurements of the silver nanowire fully covered by the black electrical tape are referred to as “dark”, measurements of the silver nanowire partially covered by the black electrical tape are referred to as “interface”, and measurements of the silver nanowire fully exposed to the xenon arc lamp are referred to as “light”. Each circle was measured at least twice. If the measurements were in disagreement, the data was typically rejected and a new coupon was tested. A resistance change of less than 25% in 500 hours of exposure was considered acceptable performance. The “dark” measurement was made as an internal control to ensure there was no adverse interaction of the OCA film with the silver nanowire in absence of xenon arc lamp exposure. A resistance change greater than 25% in any of the ‘dark”, “interface” or “light” measurement areas was considered a failure of that test coupon. Blank cells in the tables mean that no data were collected.

The percent resistance change vs. xenon arc lamp exposure time was calculated as follows: % resistance change=1/(100*(Gₜ-G₀)/G₀), where G₀ was the initial conductance without xenon arc lamp exposure and Gₜ was the conductance after t hours xenon arc lamp exposure. The parameters of the xenon arc lamp exposure conditions were as follows. The xenon arc lamp exposure condition A parameters were: irradiance 0.4 W/m² at 340 nm, 60° C. black panel temperature, 38° C. air temperature, 50% relative humidity. The xenon arc lamp exposure condition B parameters were: for the first 300 hours, samples were exposed under conditions of irradiance 0.4 W/m² at 340 nm, 60° C. black panel temperature, then for another two hundred hours the samples were exposed under conditions of irradiance 0.55 W/m² at 340 nm, 70° C. black panel temperature, 47° C. air temperature, 50% relative humidity. The Xenon arc lamp exposure condition C parameters are: irradiance 0.35 W/m² at 340 nm, 55° C. black panel temperature, 45° C. air temperature, 50% relative humidity.

### Method for Haze Measurement:

Haze was measured according to ASTM D 1003-92. The results for Adhesive Examples 5 and 6 are summarized in Table 4. Test specimens were prepared by cleaning LCD glass three times with isopropanol and completely drying it with KIMWIPES (Kimberly-Clark Corp., Neenah, Wis.). Each OCA film was cut to a size large enough to cover the entrance port of the sphere. The release liner was removed from one side and the OCA film was laminated onto the LCD glass with four passes of a small rubber hand roller. The sample was inspected visually to ensure it was free of visible distinct internal voids, particles, scratches, and blemishes. The second liner was removed prior the haze testing. The haze was measured according to ASTM D 1003-92 against the background of LCD glass using an Ultra Scan Pro Spectrophotometer (Hunter Associates Laboratory, Inc., Reston, Va.).

### Method for Color Measurement:

Color was measured according to ASTM-E1164-07/CIELAB. The results for Adhesive Examples 5 and 6 are summarized in Table 4. Test specimens were prepared by cleaning LCD glass three times with isopropyl alcohol and completely drying it with KIMWIPES (Kimberly-Clark Corp., Neenah, Wis.). Each OCA film was cut to a size large enough to cover the entrance port of the sphere. The release liner was removed from one side and the OCA film was laminated onto the LCD glass with four passes of a small rubber hand roller. The sample was inspected visually to ensure it was free of visible distinct internal voids, particles, scratches, and blemishes. The second liner was removed prior to the color test. The color was measured against the background of LCD glass according to ASTM-E1164-07/CIELAB using an ULTRASCAN PRO SPECTROPHOTOMETER (Hunter Associates Laboratory, Inc., Reston, Va.).

### Method for Durability and Anti-Whitening:

The release liner was removed from a 2 inch by 3 inch (˜5.1 cm by ˜7.6 cm) OCA strip and the strip was applied to a 5 mil (˜127 micrometers) thick primed poly(ethylene terephthalate) (PET) film. The OCA strip was secured by four passes of a small rubber hand roller, making sure no air bubbles were entrapped. The second liner was removed from the OCA strip and the OCA strip was laminated onto a 2 inch by 3 inch (˜5.1 cm by ˜7.6 cm) LCD glass or a 5 mil (˜127 micrometers) thick primed PET film. The OCA strip was secured with four passes of a small rubber hand roller, making sure no air bubbles were entrapped. The samples were placed in a testing chamber at 65° C. and 90% relative humidity and checked at regular time intervals as specified in Table 1 for the appearance of bubbles or whitening. Formation of bubbles indicated the sample had inadequate durability. For anti-whitening, a sample with visible whitening was removed from the testing chamber and deemed to pass if whitening disappeared within three minutes of removal. The results for adhesive 5 and 6 are summarized in Table 4.

### Method for 180 Decree Peel Adhesion Measurement:

ASTM D903-98 modified, 180 degree peel, 12 inch/minute. Float glass was cleaned three times with isopropanol and completely dried with KIMWIPES. An OCA test specimen was cut having dimensions of 1 inch (˜2.5 cm) wide by approximately 12 inches (˜30 cm) long. The release liner was removed from one side and the OCA was laminated to a 2 mil (˜51 micrometers) primed PET film with four passes of a small rubber hand roller, making sure no air bubbles were entrapped. The second liner was removed and the OCA secured with three passes of a five pound rubber-covered hand roller to a float glass panel, making sure no air bubbles were entrapped. After either 20 min or 72 hours dwell time at room temperature as specified in Table 4, the 180 degree peel adhesion was measured at a testing speed of 12 inch/minute (˜30 cm/minute) with an IMASS SP-2000 Slip/Peel Tester (IMASS, Inc, Accord, Mass.). Test data results are summarized in Table 4.

### Materials and Suppliers

| Chemical names | Suppliers | Supplier address |
|---|---|---|
| 2-EHA: 2-ethylhexyl acrylate | BASF | 100 Park Avenue, Florham Park, NJ 07932 |
| Acm: Acrylamide | BASF | 100 Park Avenue, Florham Park, NJ 07932 |
| HEA: 2-Hydroxy ethyl acrylate | BASF | 100 Park Avenue, Florham Park, NJ 07932 |
| EHMA: 2-ethylhexylmethylacrylate | Evonik | 299 Jefferson Road, Parsippany, NJ 07054 |
| Acrylic acid | Alfa Aesar | 30 Bond Street, Ward Hill, MA 01835-8099 |
| VAZO 52: 2,2′-Azobis(2,4- | Dupont | 1007 Market Street, Wilmington, DE 19898 |
| dimethylvaleronitrile) | | |
| DESMODURN-3300: aliphatic | Bayer | 100 Bayer Road, Pittsburgh, PA 15205-9741 |
| polyisocyanate | | |
| Bisamide, 1,1′-isophthaloyl bis (2- | 3M Co. | Maplewood, MN |
| methylaziridine) | | |
| KBM-403: 3-glydidoxypropyl | Shin-Etsu | 611 West 6th Suite 2710, Los Angeles CA, 90017 |
| triethoxysilane | | |
| Acrylic block copolymer, LA1114 | Kuraray | Kuraray Co. Ltd., Japan |
| Acrylic block copolymer, LA2330 | Kuraray | Kuraray Co. Ltd., Japan |
| Acrylic block copolymer, LA2250 | Kuraray | Kuraray Co. Ltd., Japan |
| KE-100, hydrogenated rosin ester | Arakawa | Arakawa Chemical, Japan |
| CYASORB UV-5411 | CYTEC | 5 Garret Mountain Plaza, Woodland Park, NJ |
| | | 07424 |
| TINUVIN 123 | BASF | 2090 Wagner Street, Vandalia, IL 62471 |
| TINUVIN 477 | BASF | 2090 Wagner Street, Vandalia, IL 62471 |
| IRGANOX 1076 | BASF | 100 Park Avenue, Florham Park, NJ 07932 |
| TINUVIN 479 | BASF | 2090 Wagner Street, Vandalia, IL 62471 |
| CHIMASSORB 81 | BASF | 2090 Wagner Street, Vandalia, IL 62471 |
| CHIMASSORB 90 | BASF | 2090 Wagner Street, Vandalia, IL 62471 |
| 2,4-Dihydroxybenzophenone | Aldrich | St. Louis, MO |
| 2,2′-Dihydroxybenzophenone | Aldrich | St. Louis, MO |
| TINUVIN 400 | BASF | 2090 Wagner Street, Vandalia, IL 62471 |
| TINUVIN 405 | BASF | 2090 Wagner Street, Vandalia, IL 62471 |
| TINUVIN 460 | BASF | 2090 Wagner Street, Vandalia, IL 62471 |
| TINUVIN P | BASF | 2090 Wagner Street, Vandalia, IL 62471 |
| TINUVIN 1130 | BASF | 2090 Wagner Street, Vandalia, IL 62471 |
| TINUVIN 171 | BASF | 2090 Wagner Street, Vandalia, IL 62471 |
| TINUVIN 99-2 | BASF | 2090 Wagner Street, Vandalia, IL 62471 |
| TINUVIN 900 | BASF | 2090 Wagner Street, Vandalia, IL 62471 |
| TINUVIN 928 | BASF | 2090 Wagner Street, Vandalia, IL 62471 |
| TINUVIN 384-2 | BASF | 2090 Wagner Street, Vandalia, IL 62471 |
| TINUVIN 328 | BASF | 2090 Wagner Street, Vandalia, IL 62471 |
| RF 22N release liner | SKC Haas | 12F Union Steel Bldg., 890 Daechi-dong, |
| | | Kangnam-gu, Seoul 135-524, Korea |
| RF 02N release liner | SKC Haas | 12F Union Steel Bldg., 890 Daechi-dong, |
| | | Kangnam-gu, Seoul 135-524, Korea |
| Silicone release liner T50 | Solutia Inc | 575 Maryville Center Drive, P.O. Box 66760, St. |
| | | Louis, MO 63166-6760 |
| Silicone release liner T10 | Solutia Inc | 575 Maryville Center Drive, P.O. Box 66760, St. |
| | | Louis, MO 63166-6760 |
| Primed PET, SKYROL SH81 | SKC Inc. | 863 Valley View Road, Eighty Four, PA 15330- |
| | | 9613 |

### Acrylic Copolymer 1

A mixture of 2-EHA/EHMA/HEA/Acm in mass ratio of 65/18/14/3 was prepared and diluted with ethyl acetate/toluene (1:1) to provide a monomer concentration of 50 mass %. Initiator VAZO-52 was then added in a ratio of 0.15 mass % based on monomer components, and the mixture was charged to a glass bottle where it was nitrogen-purged for 10 minutes. Subsequently, the bottle was sealed while kept under inert atmosphere and placed in a constant temperature bath at 55° C. for 6 hours. The reaction temperature was then increased to 75° C. for an additional 4 hours. A transparent viscous solution was obtained. The weight average molecular weight of the obtained acrylic copolymer was 563,000 daltons as measured by gel permeation chromatography versus polystyrene standards.

### Acrylic Copolymer 2

A mixture of 2-EHA/Acm/AA in mass ratio 92.5/7/0.5 was prepared and diluted with ethyl acetate/methanol (9:1) to provide a monomer concentration of 40 mass %. Initiator VAZO-52 was then added in a ratio of 0.1 mass % based on monomer components, and the mixture was charged to a glass bottle where it was nitrogen-purged for 10 minutes. Subsequently, the bottle was sealed while kept under inert atmosphere, and placed in a constant temperature bath at 55° C. for 20 hours. The reaction temperature was then increased to 65° C. for additional 4 hours. A transparent viscous solution was obtained. The weight average molecular weight of the obtained acrylic copolymer was 763,000 daltons as measured by gel permeation chromatography versus polystyrene standards.

### Acrylic Block Copolymer Solution 1

A mixture of LA2330/LA2250/LA1114/KE-100 in mass ratio 3:3:1:3 was prepared and diluted with ethyl acetate to a concentration of 40 mass %.

### Acrylic Block Copolymer Solution 2

A mixture of LA2330/LA2250/LA1114/KE-100 in mass ratio 1:1:1:1 was prepared and diluted with ethyl acetate to a concentration of 40 mass %.

### Comparative Example 1

To acrylic copolymer solution 1, KBM 403 and DESMODUR N3300 were added in the ratios of 0.05 and 0.4 mass parts per hundred, respectively, based on dry copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and stored for 24 hours at 65° C.

### Comparative Example 2

To acrylic copolymer solution 1, TINUVIN 477, TINUVIN 123, KBM 403 and DESMODUR N3300 were added in the ratios of 3, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 3

To acrylic copolymer solution 1, TINUVIN 477, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 4

To acrylic copolymer solution 1, TINUVIN 477, TINUVIN 123, KBM 403 and DESMODUR N3300 were added in the ratios of 1, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 5

To acrylic copolymer solution 1, TINUVIN 477, KBM 403 and DESMODUR N3300 were added in the ratios of 2, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 6

To acrylic copolymer solution 1, TINUVIN 479, KBM 403 and DESMODUR N3300 were added in the ratios of 2, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 7

To acrylic copolymer solution 1, CHIMASSORB 81, KBM 403 and DESMODUR N3300 were added in the ratios of 2, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 8

To acrylic copolymer solution 2, bisamide solution (5% in toluene) was added in the ratio of 8 mass parts per hundred based on dry copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and stored for 24 hours at 65° C.

### Comparative Example 9

Acrylic block copolymer solution 1 was coated onto a 50 micrometer-thick release film T50 and dried in an oven at 70° C. for 30 minutes. The thickness of the PSA after drying was 50 micrometers. Subsequently, this PSA surface was laminated with a 50 micrometer-thick release film T10.

### Comparative Example 10

To acrylic copolymer 2, TINUVIN 477, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and stored for 24 hours at 65° C.

### Comparative Example 11

To acrylic copolymer 2, TINUVIN P, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and stored for 24 hours at 65° C.

### Comparative Example 12

To acrylic copolymer solution 1, TINUVIN 405, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 13

To acrylic copolymer solution 1, TINUVIN 400, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 14

To acrylic copolymer solution 1, TINUVIN 460, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 15

To acrylic copolymer solution 1, CHIMASSORB 90, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Comparative Example 16

To acrylic copolymer solution 1, 2, 4-dihydroxybenzophenone, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 1

To acrylic copolymer solution 1, UV-5411, TINUVIN 123, KBM 403 and DESMODUR N3300 were added in the ratios of 3, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 2

To acrylic copolymer solution 1, UV-5411, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 3

To acrylic copolymer solution 1, UV-5411, TINUVIN 123, KBM 403 and DESMODUR N3300 were added in the ratios of 1, 1, 0.05, and 0.4 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 4

To acrylic copolymer solution 1, UV 5411, KBM 403 and DESMODUR N3300 were added in the ratios of 2, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 5

To acrylic copolymer solution 2, UV-5411, TINUVIN 123, and bisamide (5% solution in toluene) were added in the ratios of 2, 1, and 8 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C. Physical properties and performance characteristics are summarized in Table 4.

### Adhesive Example 6

To acrylic copolymer solution 2, UV-5411, TINUVIN 123, IRGANOX 1076 and bisamide (5% solution in toluene) were added in the ratios of 2, 1, 0.5, and 8 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C. Physical properties and performance characteristics are summarized in Table 4.

### Adhesive Example 7

To acrylic block copolymer solution 1, UV-5411, TINUVIN 123 were added in the ratios of 2 and 1 mass parts per hundred, respectively, based on the copolymer mass. Then, the prepared solution was coated on a 50 micrometer-thick release film T50 and dried in an oven at 70° C. for 30 minutes. The thickness of the PSA after drying was 50 micrometers. Subsequently, this PSA surface was laminated with a 50 micrometer-thick release film T10.

### Adhesive Example 8

To acrylic block copolymer solution 2, UV-5411 and TINUVIN 123 were added in the ratios of 2 and 1 mass parts per hundred, respectively, based on the copolymer mass. Then, the prepared solution was coated on a 50 micrometer-thick release film T50 and dried in an oven at 70° C. for 30 minutes. The thickness of the PSA after drying was 50 micrometers. Subsequently, this PSA surface was laminated with a 50 micrometer-thick release film T10.

### Adhesive Example 9

To acrylic copolymer 2, TINUVIN 1130, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 10

To acrylic copolymer 2, TINUVIN 171, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 11

To acrylic copolymer 2, TINUVIN 99-2, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 12

To acrylic copolymer 2, TINUVIN 900, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 13

To acrylic copolymer 2, TINUVIN 928, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 14

To acrylic copolymer 2, TINUVIN 384-2, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 15

To acrylic copolymer 2, TINUVIN 328, TINUVIN 123, and bisamide solution (5% in toluene) were added in the ratios of 2, 1, and 8 mass parts per hundred respectively based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

### Adhesive Example 16

To acrylic copolymer solution 1, 2, 2′-dihydroxybenzophenone, TINUVIN 123, KBM 403 and DESMODUR N3300 were added in the ratios of 2, 1, 0.05, and 0.4 mass parts per hundred, respectively, based on the copolymer mass. Then, the prepared solution was coated on a 50 micrometer-thick release film RF22N and dried in an oven at 70° C. for 30 minutes. The thickness of the PSA after drying was 50 micrometers. Subsequently, this PSA surface was laminated with a 50 micrometer-thick release film RF02N and aged for 24 hours at 65° C.

TABLE 1
Benzotriazole additives to stabilize silver nanowire

| | | Additives | | | % Resistance change versus Exposure time, hours | | | | | | | | |
|---|---|---|---|---|---|---|---|---|---|---|---|---|---|
| | | | | Anti- | Exposure | Test | | 100 | 200 | 300 | 400 | 438 | 500 |
| | Adhesives | UV absorber | Hals | oxidant | condition | position | Initial | hours | hours | hours | hours | hours | hours |
| Conductive | | w/o | w/o | | A | Light | 0 | | 12780 | | | | |
| film alone | | | | | | Interface | 0 | | 241 | | | | |
| | | | | | | Dark | 0 | | 12 | | | | |
| Comparative | acrylic | w/o | w/o | | A | Light | 0 | | | | | 2 | |
| Example 1 | copolymer | | | | | Interface | 0 | | | | | 68 | |
| | 1 | | | | | Dark | | | | | | 3 | |
| Comparative | acrylic | w/o | w/o | | B | Light | 0 | 2.4 | 4.2 | 0 | −6.3 | | 0 |
| Example 1 | copolymer | | | | | Interface | 0 | 2.2 | 4 | −0.1 | 1.2 | | 47 |
| | 1 | | | | | Dark | 0 | 0.5 | 2 | −0.9 | −3.1 | | 8.5 |
| Adhesive | acrylic | 2% UV-5411 | 1% | | A | Light | 0 | | 6 | | | 7 | 8 |
| Example 2 | copolymer | | TINUVIN | | | Interface | 0 | | 5 | | | 6 | 6 |
| | 1 | | 123 | | | Dark | 0 | | 4 | | | 5 | 6 |
| Adhesive | acrylic | 3% UV-5411 | 1% | | B | Light | 0 | 7.8 | 10.7 | 2.5 | 3.6 | | 8.4 |
| Example 1 | copolymer | | TINUVIN | | | Interface | 0 | 2.3 | 3.5 | −4 | 2.1 | | 4.4 |
| | 1 | | 123 | | | Dark | 0 | −0.6 | 0.1 | −8 | −5.9 | | 3.6 |
| Adhesive | acrylic | 2% UV-5411 | 1% | | B | Light | 0 | 1.5 | 6.9 | 3 | −4.2 | | 0.45 |
| Example 2 | copolymer | | TINUVIN | | | Interface | 0 | −0.5 | 3.4 | 0.6 | −5.8 | | 2.1 |
| | 1 | | 123 | | | Dark | 0 | 1.2 | 1 | −6.2 | −9.9 | | −4.2 |
| Adhesive | acrylic | 1% UV-5411 | 1% | | B | Light | 0 | 5.6 | 8 | −1.3 | −6.9 | | −2.4 |
| Example 3 | copolymer | | TINUVIN | | | Interface | 0 | 3.9 | 5.5 | −2.3 | −4.4 | | 2 |
| | 1 | | 123 | | | Dark | 0 | 0 | 0 | −7 | 8.6 | | −1.2 |
| Adhesive | acrylic | 2% UV-5411 | | | B | Light | 0 | 5 | 7.3 | 5.7 | 7 | | 12.2 |
| Example 4 | copolymer | | | | | Interface | 0 | 3.1 | 4.4 | −0.3 | 3.4 | | 12.2 |
| | 1 | | | | | Dark | 0 | 0.6 | 0.8 | −5.8 | −3.8 | | 4.5 |
| Comparative | acrylic | | | | B | Light | 0 | 3.3 | 4.6 | 2.5 | −2.5 | | −0.9 |
| Example 8 | copolymer | | | | | Interface | 0 | 3.2 | 3.5 | 3.8 | 8 | | 158 |
| | 2 | | | | | Dark | 0 | 1.2 | 1 | 2 | −1.5 | | 2.2 |
| Adhesive | acrylic | 2% UV-5411 | 1% | | B | Light | 0 | 6.6 | 9.5 | 12.5 | −5.2 | | −1.4 |
| Example 5 | copolymer | | TINUVIN | | | Interface | 0 | 3.6 | 5.5 | 7 | −1.4 | | 1.5 |
| | 2 | | 123 | | | Dark | 0 | 1 | 1.2 | 1.4 | −2 | | −0.4 |
| Adhesive | acrylic | 2% UV-5411 | 1% | 0.5% | B | Light | 0 | 5.5 | 9.3 | 13.6 | −2.5 | | 11.8 |
| Example 6 | copolymer | | TINUVIN | IRGANOX | | Interface | 0 | 3 | 5.1 | 7.1 | −0.25 | | 8.8 |
| | 2 | | 123 | 1076 | | Dark | 0 | 1 | 0.7 | 1 | −3.5 | | 0.5 |
| Adhesive | acrylic | 2% | 1% | | C | Light | 0 | | −2.0 | −4.5 | −2.6 | | −6.7 |
| Example 9 | copolymer | TINUVIN | TINUVIN | | | Interface | 0 | | −0.8 | −4.0 | 0.7 | | −1.4 |
| | 2 | 1130 | 123 | | | Dark | 0 | | −0.4 | −3.9 | 0.4 | | −1.1 |
| Adhesive | acrylic | 2% | 1% | | C | Light | 0 | | −1.8 | −1.4 | −5.7 | | 5.5 |
| Example 10 | copolymer | TINUVIN | TINUVIN | | | Interface | 0 | | −5.6 | −2.7 | −0.7 | | −1.6 |
| | 2 | 171 | 123 | | | Dark | 0 | | 0.8 | 1.1 | −0.7 | | 0 |
| Adhesive | acrylic | 2% | 1% | | C | Light | 0 | | −2.7 | −1.4 | −5.2 | −3.6 | |
| Example 11 | copolymer | TINUVIN | TINUVIN | | | Interface | 0 | | −0.7 | 1.5 | −5.2 | −3.8 | |
| | 2 | 99-2 | 123 | | | Dark | 0 | | 0 | 2.6 | −4.1 | −4.4 | |
| Adhesive | acrylic | 2% | 1% | | C | Light | 0 | | −1.3 | −3.2 | −4.9 | | −2.0 |
| Example 12 | copolymer | TINUVIN | TINUVIN | | | Interface | 0 | | −1.0 | −4.7 | −3.9 | | −0.4 |
| | 2 | 900 | 123 | | | Dark | 0 | | 0.4 | −2.2 | −1.7 | | 0 |
| Adhesive | acrylic | 2% | 1% | | C | Light | 0 | | −2.3 | −4.2 | −5.5 | | −5.8 |
| Example 13 | copolymer | TINUVIN | TINUVIN | | | Interface | 0 | | −0.4 | −3.5 | −2.0 | | −3.3 |
| | 2 | 928 | 123 | | | Dark | 0 | | −1.4 | −5.4 | −2.7 | | −3.6 |
| Adhesive | acrylic | 2% | 1% | | C | Light | 0 | | −4.1 | −4.0 | −6.5 | | −3.7 |
| Example 14 | copolymer | TINUVIN | TINUVIN | | | Interface | 0 | | −2.7 | −1.7 | −4.2 | | −2.7 |
| | 2 | 384-2 | 123 | | | Dark | 0 | | −0.7 | 0 | −2.2 | | −1.0 |
| Adhesive | acrylic | 2% | 1% | | C | Light | 0 | | −0.7 | −1.0 | −0.4 | | −2.0 |
| Example 15 | copolymer | TINUVIN | TINUVIN | | | Interface | 0 | | 1.0 | 0.6 | 0.4 | | 1.3 |
| | 2 | 328 | 123 | | | Dark | 0 | | 0.4 | 1.0 | 0 | | 0.4 |
| Comparative | acrylic | 2% | 1% | | C | Light | 0 | | 3.3 | 10.9 | 10.6 | | 25 |
| Example 11 | copolymer | TINUVIN | TINUVIN | | | Interface | 0 | | 1.6 | 5.5 | 7.4 | | 8.2 |
| | 2 | P | 123 | | | Dark | 0 | | 1.0 | 2.0 | 0.6 | | 11.3 |
| Comparative | acrylic | | | | B | Light | 0 | 1244 | 2480 | | | | |
| Example 9 | block | | | | | Interface | 0 | 323 | 409 | | | | |
| | copolymer | | | | | Dark | 0 | −1.8 | −0.15 | | | | |
| | 1 | | | | | | | | | | | | |
| Adhesive | acrylic | 2% UV-5411 | 1% | | B | Light | 0 | 4 | 7.25 | 4.7 | 0.75 | | 4.5 |
| Example 7 | block | | TINUVIN | | | Interface | 0 | 1.25 | 3.7 | 3.2 | 1.6 | | 4.7 |
| | copolymer | | 123 | | | Dark | 0 | −0.55 | −0.1 | −0.4 | −1.25 | | 0 |
| | 1 | | | | | | | | | | | | |
| Adhesive | acrylic | 2% UV-5411 | 1% | | B | Light | 0 | 5.2 | 8.8 | 9.5 | 2.1 | | 7.1 |
| Example 8 | block | | TINUVIN | | | Interface | 0 | 3.1 | 6.5 | 7.7 | 2.2 | | 4.8 |
| | copolymer | | 123 | | | Dark | 0 | −1.6 | −1 | −0.25 | −1.7 | | 1.9 |
| | 2 | | | | | | | | | | | | |

TABLE 2
Benzophenone effect on silver nanowire light stability

| | | | | % Resistance change versus Exposure time, hours | | | | | | | | |
|---|---|---|---|---|---|---|---|---|---|---|---|---|
| | | Additives | | Exposure | Test | | 100 | 200 | 300 | 400 | 438 | 500 |
| | Adhesives | UV absorber | Hals | condition | position | Initial | hours | hours | hours | hours | hours | hours |
| Conductive | | w/o | w/o | A | Light | 0 | | 12780 | | | | |
| film alone | | | | | Interface | 0 | | 241 | | | | |
| | | | | | Dark | 0 | | 12 | | | | |
| Comparative | acrylic | w/o | w/o | A | Light | 0 | | | | | 2 | |
| Example 1 | copolymer 1 | | | | Interface | 0 | | | | | 68 | |
| | | | | | Dark | 0 | | | | | 3 | |
| Comparative | acrylic | w/o | w/o | B | Light | 0 | 2.4 | 4.2 | 0 | −6.3 | | 0 |
| Example 1 | copolymer 1 | | | | Interface | 0 | 2.2 | 4 | −0.1 | 1.2 | | 47 |
| | | | | | Dark | 0 | 0.5 | 2 | −0.9 | −3.1 | | 8.5 |
| Comparative | acrylic | 2% CHIMASSORB 81 | w/o | B | Light | 0 | 4.2 | 53.5 | 256.9 | | | |
| Example 7 | copolymer 1 | | | | Interface | 0 | 2.9 | 21.3 | 71.1 | | | |
| | | | | | Dark | 0 | 0.4 | −0.6 | −5.8 | | | |
| Comparative | acrylic | 2% CHIMASSORB 90 | 1% TINUVIN | A | Light | 0 | | 5.4 | 12.7 | | | 23.4 |
| Example 15 | copolymer 1 | | 123 | | Interface | 0 | | 4.1 | 8.5 | | | 9.4 |
| | | | | | Dark | 0 | | 1.2 | 3.2 | | | 1.2 |
| Comparative | acrylic | 2% 2,4-Dihydroxy- | 1% TINUVIN | A | Light | 0 | | 5.1 | 7.2 | | | 38.2 |
| Example 16 | copolymer 1 | benzophenone | 123 | | Interface | 0 | | 5.0 | 5.4 | | | 15.5 |
| | | | | | Dark | 0 | | 3 | 1.9 | | | 1.7 |
| Adhesive | acrylic | 2% 2,2′-Dihydroxy- | 1% TINUVIN | A | Light | 0 | | 0 | 0.7 | | | 17 |
| Example 16 | copolymer 1 | benzophenone | 123 | | Interface | 0 | | 0 | −1.5 | | | 8.4 |
| | | | | | Dark | 0 | | −1.4 | −2.6 | | | 0.4 |

TABLE 3
Hydroxyphenyltriazine effect on silver nanowire light stability

| | | % Resistance change versus Exposure time, hours | | | | | | | | | | |
|---|---|---|---|---|---|---|---|---|---|---|---|---|
| | | | | Exposure | Test | | 100 | 200 | 300 | 400 | 438 | 500 |
| | Adhesives | UV absorber | Hals | condition | position | Initial | hours | hours | hours | hours | hours | hours |
| Conductive film | | w/o | w/o | A | Light | 0 | | 12780 | | | | |
| alone | | | | | Interface | 0 | | 241 | | | | |
| | | | | | Dark | 0 | | 12 | | | | |
| Comparative | acrylic | w/o | w/o | A | Light | 0 | | | | | 2 | |
| Example 1 | copolymer 1 | | | | Interface | 0 | | | | | 68 | |
| | | | | | Dark | | | | | | 3 | |
| Comparative | acrylic | w/o | w/o | B | Light | 0 | 2.4 | 4.2 | 0 | −6.3 | | 0 |
| Example 1 | copolymer 1 | | | | Interface | 0 | 2.2 | 4 | −0.1 | 1.2 | | 47 |
| | | | | | Dark | 0 | 0.5 | 2 | −0.9 | −3.1 | | 8.5 |
| Comparative | acrylic | 2% TINUVIN | 1% TINUVIN | A | Light | 0 | | 87 | | | 310 | 568 |
| Example 3 | copolymer 1 | 477 | 123 | | Interface | 0 | | 42 | | | 144 | 234 |
| | | | | | Dark | 0 | | | | | 11 | 11 |
| Comparative | acrylic | 3% TINUVIN | 1% TINUVIN | B | Light | 0 | 12 | 13.2 | 20.7 | 54 | | 82 |
| Example 2 | copolymer 1 | 477 | 123 | | Interface | 0 | 7.4 | 10.5 | 6.3 | 25.5 | | 48.7 |
| | | | | | Dark | 0 | 1.2 | 0.1 | −6.2 | −3.4 | | 3.9 |
| Comparative | acrylic | 2% TINUVIN | 1% TINUVIN | B | Light | 0 | 13.6 | 18.2 | 8.4 | 7.2 | | 21.3 |
| Example 3 | copolymer 1 | 477 | 123 | | Interface | 0 | 9.7 | 12.3 | 3.8 | 10 | | 23 |
| | | | | | Dark | 0 | 0.7 | 1 | −7.3 | −5.7 | | 7 |
| Comparative | acrylic | 1% TINUVIN | 1% TINUVIN | B | Light | 0 | 9.7 | 19.3 | 7.1 | 12.1 | | 46.9 |
| Example 4 | copolymer 1 | 477 | 123 | | Interface | 0 | 5.7 | 11.4 | 1.3 | 7.5 | | 29.1 |
| | | | | | Dark | 0 | −2 | 1 | −8.2 | −7.8 | | 1.6 |
| Comparative | acrylic | 2% TINUVIN | | B | Light | 0 | 4.6 | 5.9 | 4.7 | 54.7 | | 67 |
| Example 5 | copolymer 1 | 477 | | | Interface | 0 | 3.5 | 4.8 | 6.5 | 28.4 | | 72 |
| | | | | | Dark | 0 | 0.6 | 3.7 | −0.4 | −6 | | 4 |
| Comparative | acrylic | 2% | | B | Light | 0 | 4.5 | 1060 | | | | |
| Example 6 | copolymer 1 | TINUVIN479 | | | Interface | 0 | 2.4 | 166 | | | | |
| | | | | | Dark | 0 | 1 | −0.3 | | | | |
| Comparative | acrylic | 2% TINUVIN | 1% TINUVIN | A | Light | 0 | | 14500 | | | | |
| Example 12 | copolymer 1 | 405 | 123 | | Interface | 0 | | 339 | | | | |
| | | | | | Dark | 0 | | 0.6 | | | | |
| Comparative | acrylic | 2% TINUVIN | 1% TINUVIN | A | Light | 0 | | 14300 | | | | |
| Example 13 | copolymer 1 | 400 | 123 | | Interface | 0 | | 389 | | | | |
| | | | | | Dark | 0 | | −3.0 | | | | |
| Comparative | acrylic | 2% TINUVIN | 1% TINUVIN | A | Light | 0 | | | | | | |
| Example 14 | copolymer 1 | 460 | 123 | | Interface | 0 | | | | | | |
| | | | | | Dark | 0 | | | | | | |

TABLE 4
Physical properties and performance characteristics for two examples

| | | | Results for Adhesive | Results for Adhesive |
|---|---|---|---|---|
| Testing | | | Example 5 | Example 6 |
| Durability(65 C./90% RH, 14 days) | | 5 mil* PET/ | No bubble | No bubble |
| | | 5 mil PET | | |
| | | 5 mil PET/ | No bubble | No bubble |
| | | LCD Glass | | |
| Anti-whitening(65 C./90% RH) | | 5 mil PET/ | Good | Good |
| | | 5 mil PET | | |
| | | 5 mil PET/ | Good | Good |
| | | LCD Glass | | |
| Optics | Yellowing, b* | | 0.23 | 0.24 |
| | Haze % | | 0.18 | 0.2 |
| | Transmittance % (400-800 nm) | | 92.3 | 92.3 |
| 180 degree peel | Float glass | 20 min dwell | 52 (57) | 52 (57) |
| Adhesion, | | 72 hour dwell | 49 (54) | 54 (59) |
| oz/in (N/dm) | PET | 20 min dwell | 51 (56) | 51 (56) |
| | | 72 hour dwell | 57 (62) | 60 (66) |
| | PMMA | 20 min dwell | 63 (69) | 64 (70) |
| | | 72 hour dwell | 65 (71) | 66 (72) |
| | PC | 20 min dwell | 66 (72) | 62 (68) |
| | | 72 hour dwell | 67 (73) | 70 (77) |

*5 mil is ~127 micrometers

Although the present invention has been described with reference to preferred embodiments, workers skilled in the art will recognize that changes may be made in form and detail without departing from the spirit and scope of the invention.

What is claimed is:

1. An adhesive composition for stabilizing an electrical conductor comprising:
a base polymer; and
one of a benzotriazole and a benzophenone;
wherein when the adhesive composition is in contact with the electrical conductor, the electrical conductor has less than about a 20% change in electrical resistance over a period of about 500 hours of light exposure.

2. The adhesive composition of claim 1, further comprising at least one of a hindered amine light stabilizer and an anti-oxidant.

3. The adhesive composition of claim 1, wherein the benzotriazole is hydroxyphenylbenzotriazole.

4. The adhesive composition of claim 1, wherein the benzophenone is 2,2′-dihydroxybenzophenone.

5. The adhesive composition of claim 1, wherein the one of a benzotriazole and a benzophenone comprises between about 0.1 and about 5% by weight of the adhesive composition.

6. The adhesive composition of claim 1, wherein the base polymer comprises one of a polyester, polyurethane, polyurea, polyamide, silicone, polyolefin, acrylic block copolymer, rubber block copolymer or random (meth)acrylic copolymer.

7. The adhesive composition of claim 1, wherein the electrical conductors are based on metallic conductors.

8. The adhesive composition of claim 7, wherein the metallic conductors comprise silver or copper.

9. The adhesive composition of claim 7, wherein the metallic conductors are metallic nanoparticles, nanorods and nanowires.

10. The adhesive composition of claim 1, further comprising a crosslinker.

11. The adhesive composition of claim 1, wherein when the adhesive composition is coated on the electrical conductor, the electrical conductor has less than about a 10% change in electrical resistance over a period of about 500 hours of light exposure.

12. A method of stabilizing an electrical conductor comprising:
providing an adhesive composition comprising:
a base polymer; and
an additive for absorbing UV light; and
coating the adhesive composition on the electrical conductor;
wherein when the adhesive composition is coated on the electrical conductor, the electrical conductor has less than about a 20% change in electrical resistance over a period of about 500 hours of light exposure.

13. The method of claim 12, wherein the additive for absorbing UV light comprises one of a benzotriazole and a benzophenone.

14. The method of claim 12, further comprising at least one of a hindered amine light stabilizer and an anti-oxidant.

15. The method of claim 12, wherein the additive comprises between about 0.1 and about 5% by weight of the adhesive composition.

16. The method of claim 12, wherein the base polymer comprises one of a polyester, polyurethane, polyurea, polyamide, silicone, polyolefin, acrylic block copolymer, rubber block copolymer or random (meth)acrylic copolymer.

17. The method of claim 12, wherein the electrical conductors are based on metallic conductors.

18. The adhesive method of claim 17, wherein the metallic conductors are metallic nanoparticles, nanorods and nanowires.

19. The method of claim 12, further comprising a crosslinker.

20. The method of claim 12, wherein when the adhesive composition is coated on the electrical conductor, the electrical conductor has less than about a 10% change in electrical resistance over a period of about 500 hours of light exposure.
